(19) United States
(12) Patent Application Publication
(10) Pub. No.: US 2005/0122436 A1
(43) Pub. Date: Jun. 9, 2005

(54) Television tuner which does not deteriorate picture quality even at the time of weak electric field

(76) Inventor: Masaki Yamamoto, Fukushima-ken (JP)

Correspondence Address: BRINKS HOFER GILSON & LIONE, P.O. BOX 10395, CHICAGO, IL, 60610, US

(21) Appl. No.: 10/978,920

(22) Filed: Nov. 1, 2004

(30) Foreign Application Priority Data
Nov. 6, 2003 (JP) 2003-272291

(51) Int. Cl. H04N 5/50

(52) U.S. Cl. 348/731

(57) ABSTRACT

A television tuner contains a mixer unit for converting a television signal into an intermediate frequency signal and an intermediate frequency tuning circuit provided at the next stage of the mixer unit for passing the intermediate frequency signal. The intermediate frequency tuning circuit is switched such that a tuning frequency has different values according to whether the television signal is at least a weak electric field or a strong electric field. The tuning frequency is tuned to a frequency close to a picture intermediate frequency when the television signal is at least the weak electric field, and the tuning frequency is tuned to a frequency close to a sound intermediate frequency when the television signal is at least the strong electric field.

This application claims the benefit of priority to Japanese Patent Application No. 2003-272291 filed on Nov. 6, 2003, herein incorporated by reference.

### BACKGROUND OF THE INVENTION

1. Field of the Invention

The present invention relates to a television tuner.

2. Description of the Related Art

Conventionally, in a television tuner as shown in FIG. 6, a signal received by an antenna 40 is pre-selected by an antenna tuning unit (ANT tuning unit) 41 and is then amplified by a radio-frequency amplifying unit (RF AMP) 42. Then, the amplified signal is input to a mixer unit (MIX) 44 after unnecessary signals are further removed by a subsequent radio-frequency tuning unit (RF tuning unit) 43. The television signal is mixed with a local oscillating signal in the mixer unit 44 and converted into an intermediate frequency signal. The intermediate frequency signal is balanced-output from the mixer unit. An intermediate frequency coupling circuit (IF coupling circuit) 45 provided at the next stage of the mixer unit 44 is composed of a balanced circuit having balanced input terminals and balanced output terminals.

An intermediate frequency tuning circuit 45a connected between the balanced input terminals comprises inductors 45₂ and 45₃ that are connected in series and a capacitor 45₁ that is connected parallel to the inductors. A tuning frequency of the intermediate frequency tuning circuit is nearly an intermediate frequency (for example, 56.5 MHz in a television system of Japan) between a picture intermediate frequency (for example, 58.75 MHz in the television system of Japan) and a sound intermediate frequency (for example, 54.25 MHz in the television system of Japan). A voltage applied to a power source terminal 45₁₁ is supplied to the mixer unit 44 via the two inductors 45₂ and 45₃. Further, an adjacent channel trap circuit 45b connected between one input terminal and one output terminal comprises a capacitor 45₆ and an inductor 45₅ that are connected in series, and a capacitor 45₄ that is connected parallel thereto. The adjacent channel trap circuit 45b attenuates a picture intermediate frequency of an adjacent channel. The other input terminal and the other output terminal are connected to each other through a capacitor 45₁₂.

An intermediate frequency amplifying unit (IF AMP) 46 connected to the intermediate frequency coupling circuit 45 is composed of a balanced circuit (for example, see Japanese Unexamined Patent Application Publication No. 2002-271225 (FIG. 5)).

In the above-mentioned tuning circuit, the tuning frequency thereof is set to be nearly an intermediate frequency between the picture intermediate frequency and the sound intermediate frequency. Therefore, when receiving a television signal having an intermediate electric field or a strong electric field or more, a satisfactory picture output characteristic is obtained. However, when receiving a television signal having a weak electric field, there is a problem in that the level of the picture intermediate frequency signal is lowered, and thus insufficient sensitivity is obtained, thereby rapidly deteriorating the picture quality displayed on a screen.

### SUMMARY OF THE INVENTION

Accordingly, an object of the present invention is to provide a television tuner capable of obtaining a sufficient picture output characteristic without deteriorating the picture quality displayed on a television screen even at the time when receiving a television signal having a weak electric field.

A television tuner according to the present invention comprises a mixer unit for converting a television signal into an intermediate frequency signal and an intermediate frequency tuning circuit provided at the next stage of the mixer unit for passing the intermediate frequency signal. The intermediate frequency tuning circuit is switched such that a tuning frequency has different values according to whether the television signal is a weak electric field or a strong electric field. The tuning frequency is tuned to a frequency close to a picture intermediate frequency when the television signal is at least the weak electric field, and the tuning frequency is tuned to a frequency close to a sound intermediate frequency when the television signal is at least the strong electric field.

Further, the tuning frequency is high when the television signal is at least the weak electric field, and the tuning frequency is low when the television signal is at least the strong electric field.

Furthermore, the tuning frequency is high when the television signal is the weak electric field, and the tuning frequency is low when the television signal is the strong electric field or an intermediate electric field.

Moreover, the tuning frequency is set close to the picture intermediate frequency when the television signal is the weak electric field, and the tuning frequency is set substantially to an intermediate frequency between the picture intermediate frequency and the sound intermediate frequency when the television signal is the strong electric field or the intermediate electric field.

Further, the television tuner according to the present invention further comprises an intermediate frequency amplifier for amplifying an intermediate frequency signal output from the intermediate frequency tuning circuit and switching means controlled by the intermediate frequency signal output from the intermediate frequency amplifier. A varactor diode for converting the tuning frequency is provided in the intermediate frequency tuning circuit, and a voltage applied to the varactor diode is switched by the switching means.

According to the present invention, a television tuner comprises a mixer unit for converting a television signal into an intermediate frequency signal and an intermediate frequency tuning circuit provided at the next stage of the mixer unit for passing the intermediate frequency signal. The intermediate frequency tuning circuit is switched such that a tuning frequency has different values according to whether the television signal is a weak electric field or a strong electric field. The tuning frequency is tuned to a frequency close to a picture intermediate frequency when the television signal is at least the weak electric field, and the tuning frequency is tuned to a frequency close to a sound intermediate frequency when the television signal is at least the strong electric field. Therefore, in case of the weak electric field, the level of the picture intermediate frequency signal becomes high, and thus a picture having a high S/N ratio is obtained. Further, in case of the strong electric field, since the level of the picture intermediate frequency signal is not excessively high, a high-quality image having no distortion can be obtained.

Further, the tuning frequency is high when the television signal is at least the weak electric field, and the tuning frequency is low when the television signal is at least the strong electric field. Thus, when a television tuner of an NTSC system is adopted, a high-quality image can be obtained.

Furthermore, the tuning frequency is high when the television signal is the weak electric field, and the tuning frequency is low when the television signal is the strong electric field or an intermediate electric field. Thus, it is possible to receive television signals in the range of the weak electric field to the strong electric field and thus to display a high-quality image.

Moreover, the tuning frequency is set close to the picture intermediate frequency when the television signal is the weak electric field, and the tuning frequency is set substantially to an intermediate frequency between the picture intermediate frequency and the sound intermediate frequency when the television signal is the strong electric field or the intermediate electric field. Thus, it is possible to receive television signals in the range of the weak electric field to the strong electric field and thus to display a high-quality image.

Further, the television tuner according to the present invention further comprises an intermediate frequency amplifier for amplifying an intermediate frequency signal output from the intermediate frequency tuning circuit and switching means controlled by the intermediate frequency signal output from the intermediate frequency amplifier. A varactor diode for converting the tuning frequency is provided in the intermediate frequency tuning circuit, and a voltage applied to the varactor diode is switched by the switching means. Thus, it is possible to automatically switch the tuning frequency in accordance with the difference between television signal levels.

### BRIEF DESCRIPTION OF THE DRAWINGS

FIG. 1 is a circuit diagram showing a configuration of a television tuner according to the present invention;

FIG. 2 is an equivalent circuit diagram of the television tuner according to the present invention at the time of a weak electric filed;

FIG. 3 is a view illustrating an intermediate frequency tuning characteristic of the television tuner according to the present invention at the time of the weak electric field;

FIG. 4 is an equivalent circuit diagram of the television tuner according to the present invention at the time of a strong electric filed;

FIG. 5 is a view illustrating an intermediate frequency tuning characteristic of the television tuner according to the present invention at the time of the strong electric field; and

FIG. 6 is a circuit diagram showing a configuration of a conventional television tuner.

### DESCRIPTION OF THE PREFERRED EMBODIMENT

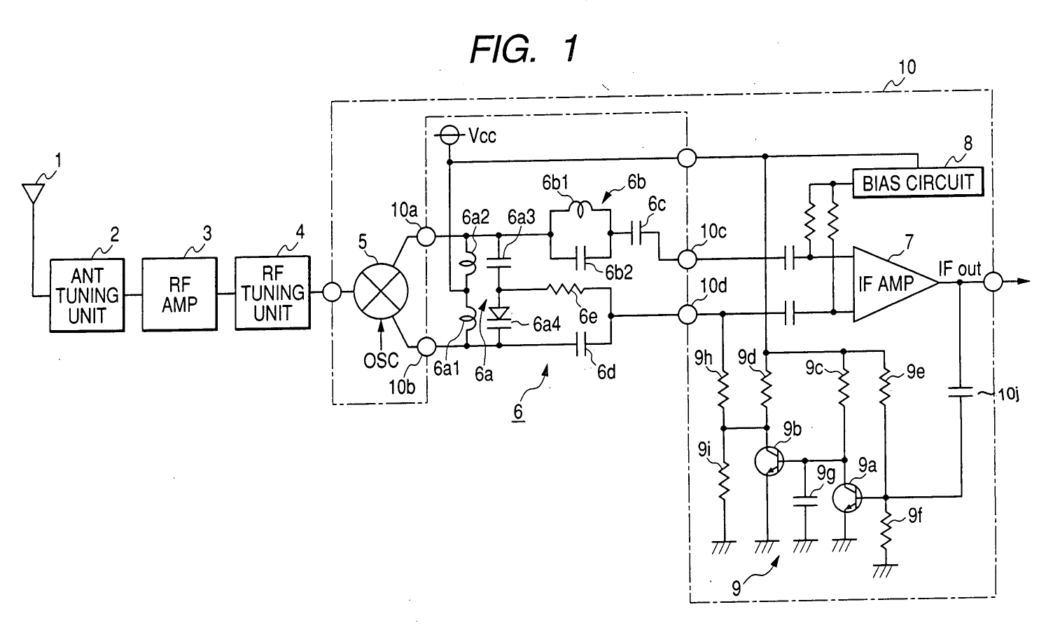

Hereinafter, a television tuner of the present invention will be described with reference to FIGS. 1 to 5. FIG. 1 shows the entire circuit configuration of the television tuner. A television signal received by an antenna 1 is pre-selected by an antenna tuning unit (ANT tuning unit) 2 and is then amplified by a radio-frequency amplifying unit (RF AMP) 3. Subsequently, the amplified signal is input to a mixer unit (MIX) 5 after unnecessary signals are further removed by a subsequent radio-frequency tuning unit (RF tuning unit) 4. A local oscillating signal from an oscillator (OSC) (not shown) is input to the mixer unit S. The television signal is mixed with the local oscillating signal and converted into an intermediate frequency signal. The intermediate frequency signal is balanced-output from the mixer unit 5. The mixer unit 5 is provided in an integrated circuit 10. The integrated circuit 10 is provided with balanced output terminals 10a and 10b for outputting the intermediate frequency signal from the mixer unit 5 and balanced input terminals 10c and 10d for inputting the intermediate frequency signal to the integrated circuit 10.

An intermediate frequency coupling circuit (IF coupling circuit) 6 provided between the balanced output terminals 10a and 10b and the balanced input terminals 10c and 10d is composed of a balanced circuit. An intermediate frequency tuning circuit 6a is connected between the balanced output terminals 10a and 10b. An adjacent channel trap circuit 6b is connected between the output terminal 10a and the input terminal 10c via a capacitor 6c. Further, a capacitor 6d connects the output terminal 10b to the input terminal 10d.

The intermediate frequency tuning circuit 6a is composed of a parallel tuned circuit in which two inductors 6a1 and 6a2 connected in series are connected parallel to a capacitor 6a3 and a varactor diode 6a4 that are connected in series. A voltage applied to a power source terminal Vcc is supplied to the mixer unit 5 through the two inductors 6a1 and 6a2. At this time, the voltage of the power source terminal Vcc is applied to a cathode of the varactor diode 6a4 through the inductor 6a1. Further, an anode of the varactor diode 6a4 is connected to the input terminal 10d through a resistor 6e.

The adjacent channel trap circuit 6b is composed of a parallel resonance circuit comprising an inductor 6b1 and a capacitor 6b2. The adjacent channel trap circuit 6b attenuates a picture intermediate frequency of an adjacent channel by the resonance frequency.

An integrated circuit 10 is provided with an intermediate frequency amplifier (IF AMP) 7 coupled to the balanced input terminals 10c and 10d and a bias circuit 8 for supplying a bias voltage to an amplifying element (not shown) inside the intermediate frequency amplifier 7. The bias circuit 8 generates a bias voltage from the power source voltage. Further, the integrated circuit 10 is provided with switching means 9 whose ON or OFF state is controlled by the intermediate frequency signal output from the intermediate frequency amplifier 7.

The switching means 9 includes two transistors 9a and 9b whose emitters are connected to the ground and whose collectors are respectively pulled-up to the power source terminal Vcc via resistors 9c and 9d. A bias voltage obtained by dividing the voltage of the power source terminal Vcc by resistors 9e and 9f is applied to a base of the first transistor 9a. The base is coupled to an output terminal of the intermediate frequency amplifier 7 via a coupling capacitor 10j. A collector of the first transistor 9a and a base of the second transistor 9b are connected to each other and are also connected to the ground via a capacitor 9g. A collector of the second transistor 9b is connected to the input terminal 10d via a resistor 9h and is also connected to the ground via a resistor 9i.

The switching means 9 having the above-mentioned structure switches the voltage of an anode of the varactor diode 6a4 so as to convert the tuning frequency of the intermediate frequency tuning circuit 6a into two kinds of high and low frequencies in accordance with the difference between television signal levels. In order to achieve this, when the intermediate frequency signal output from the intermediate frequency amplifier 7 is based on a television signal having at least a strong electric field or more, the first transistor 9a is biased so as to be turned on by the intermediate frequency signal. On the other side, when the intermediate frequency signal is based on a television signal having at least a weak electric field, the first transistor 9a is biased so as to be turned off by the intermediate frequency signal.

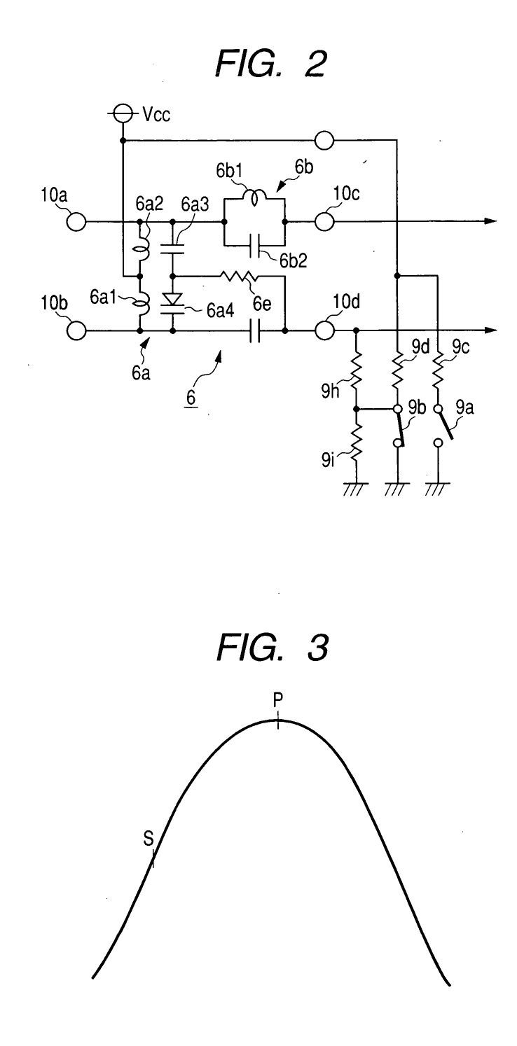

Therefore, when the level of a television signal is less than the weak electric field, the first transistor 9a becomes an off state, and the second transistor 9b is turned on. As a result, as shown in the equivalent circuit diagram of FIG. 2, the voltage of the anode of the varactor diode 6a4 becomes nearly 0 volt, and the voltage between two terminals thereof is equal to the voltage of the power source terminal Vcc. Therefore, the capacitance of the varactor diode 6a4 becomes small. A tuning frequency of the intermediate frequency tuning circuit 6a at this time, for example, is set in accordance with the values of the inductors 6a1 and 6a2 and the capacitor 6a3 to have a frequency close to a picture intermediate frequency P (58.75 MHz) of the television system of Japan, as shown in FIG. 3.

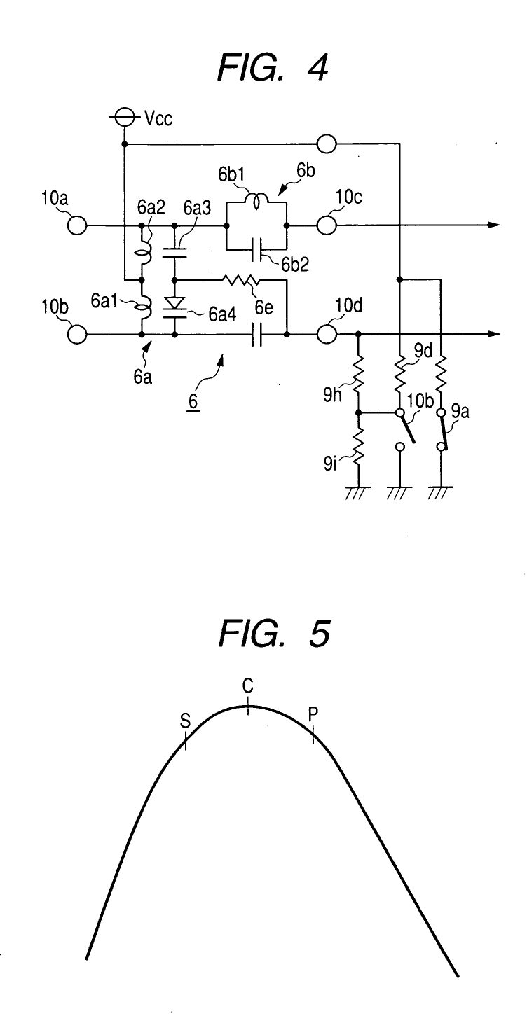

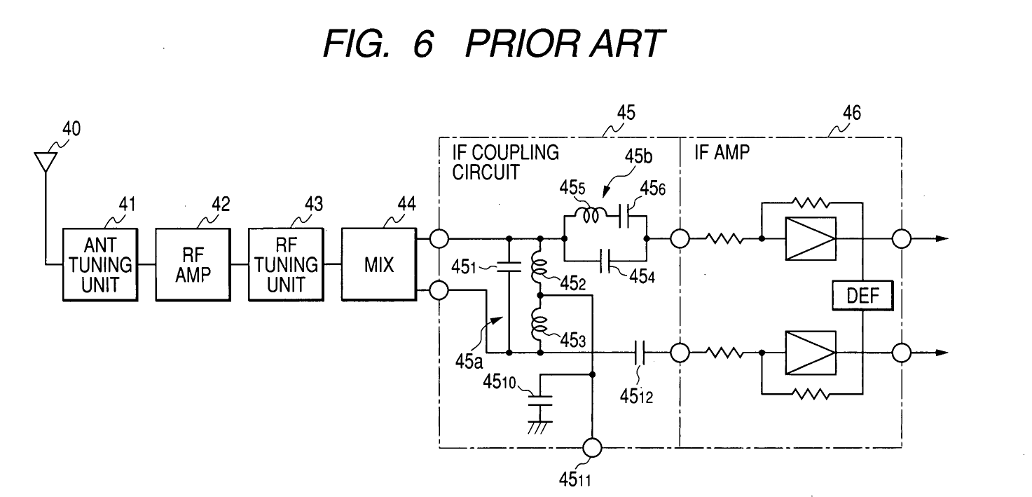

Further, when the level of the television signal is more than the strong electric field, the first transistor 9a is turned on, so that the second transistor 9b is turned off. As a result, as shown in the equivalent circuit diagram of FIG. 4, the voltage obtained by dividing the voltage of the power source terminal Vcc by the resistors 9d and 9i is applied to the anode of the varactor diode 6a4. Therefore, the voltage between both terminals of the varactor diode 6a4 becomes less than the voltage of the power source terminal Vcc, and thus the capacitance of the varactor diode 6a4 becomes large. For example, as shown in FIG. 5, the tuning frequency of the intermediate frequency tuning circuit 6a at this time is set in accordance with the values of the inductors 6a1 and 6a2 and the capacitor 6a3 to have a frequency close to an intermediate frequency C (56.5 MHz) between the picture intermediate frequency P (58.75 MHz) and a sound intermediate frequency S (54.25 MHz) of the television system of Japan.

That is, the tuning frequency of the intermediate frequency tuning circuit 6a is switched to two kinds of frequencies in accordance with the difference between input television signal levels. In case of a weak electric field, the tuning frequency is switched to a frequency close to the picture intermediate frequency. In case of a strong electric field, the tuning frequency is switched to a frequency close to the sound intermediate frequency. In the NTSC system adapted in Japan, Unite State of America, and so on, the picture intermediate frequency is higher than the sound intermediate frequency. Thus, in case of the weak electric field, the tuning frequency is high. On the other side, in case of the strong electric field, the tuning frequency is low. When a system in which the picture intermediate frequency is lower than the sound intermediate frequency is adopted, the tuning frequency is low in case of the weak electric field. On the other hand, the tuning frequency is high in case of the strong electric field.

Further, when the level of the television signal is an intermediate level between the weak electric field and the strong electric field, that is, an intermediate electric field, the tuning frequency of an intermediate frequency tuning circuit may be set to a frequency close to a picture intermediate frequency, similar to the case of the weak electric field, or may be set to a frequency close to a sound intermediate frequency, similar to the case of the strong electric field. Here, this setting is determined by the receiving sensitivity of the television receiver. However, since a sufficient receiving sensitivity is generally obtained in the intermediate electric field, it is advisable to set the tuning frequency of an intermediate frequency tuning circuit at a frequency close to the sound intermediate frequency, similar to the case of the strong electric field.

1. A television tuner comprising:
a mixer unit for converting a television signal into an intermediate frequency signal; and
an intermediate frequency tuning circuit provided at the next stage of the mixer unit for passing the intermediate frequency signal,
wherein the intermediate frequency tuning circuit is switched such that a tuning frequency has different values according to whether the television signal is a weak electric field or a strong electric field, and
wherein the tuning frequency is tuned to a frequency close to a picture intermediate frequency when the television signal is at least the weak electric field, and the tuning frequency is tuned to a frequency close to a sound intermediate frequency when the television signal is at least the strong electric field.

2. The television tuner according to claim 1,
wherein the tuning frequency is high when the television signal is at least the weak electric field, and the tuning frequency is low when the television signal is at least the strong electric field.

3. The television tuner according to claim 2,
wherein the tuning frequency is high when the television signal is the weak electric field, and the tuning frequency is low when the television signal is the strong electric field or an intermediate electric field.

4. The television tuner according to claim 3,
wherein the tuning frequency is set close to the picture intermediate frequency when the television signal is the weak electric field, and the tuning frequency is set substantially to an intermediate frequency between the picture intermediate frequency and the sound intermediate frequency when the television signal is the strong electric field or the intermediate electric field.

5. The television tuner according to claim 4, further comprising:
an intermediate frequency amplifier for amplifying an intermediate frequency signal output from the intermediate frequency tuning circuit; and
switching means controlled by the intermediate frequency signal output from the intermediate frequency amplifier,
wherein a varactor diode for converting the tuning frequency is provided in the intermediate frequency tuning circuit, and
wherein a voltage applied to the varactor diode is switched by the switching means.
